(19) United States
(12) Patent Application Publication
(10) Pub. No.: US 2003/0177705 A1
(43) Pub. Date: Sep. 25, 2003

(54) Panel assembly for use with reflective roof and methods of use

(76) Inventors: Jack R. Forbis, Sr., Waco, TX (US); Ann R. Forbis, Waco, TX (US)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/394,367

(22) Filed: Mar. 21, 2003

Related U.S. Application Data
(60) Provisional application No. 60/366,464, filed on Mar. 21, 2002.

(51) Int. Cl. E04B 1/34; B62D 63/04

(52) U.S. Cl. 52/3

(57) ABSTRACT

A panel assembly for decreasing reflection of solar radiation by the exterior of a building, such as a white roof. The assembly includes dark or radiation absorbent panels suspended above the roof or walls of a building by attachment to cables, upright support posts or other support mechanisms. A method for warming a cool roof includes covering the roof with an array of dark panels. Various environmental incentives and benefits may be obtained by use of the panel assembly.

### PRIORITY CLAIM

The present application claims priority under 35 U.S.C. § 119(e) to U.S. Provisional Application Serial No. 60/366464 filed Mar. 21, 2002.

### TECHNICAL FIELD OF THE INVENTION

The present invention relates to panel assemblies and in particular panel assemblies for decreasing or preventing heat reflection from a building's “cool roof”, which is envisioned to help improve its energy performance and thereby help reduce heating costs for such a building in winter months as well as provide other benefits. The application includes methods of using such an assembly.

### BACKGROUND OF THE INVENTION

The transfer of heat takes place in three ways: by conduction, convection and radiation. The transfer of heat energy by radiation makes possible the transfer of large amounts of heat from the sun to the earth. When the air inside a building is cooler than the roof and outside air, conduction carries the sun's heat through the roof where it is distributed into the attic space or other interior areas near the roof by radiation and convection. Similarly, heat can also be transferred through the exterior walls of a building to its interior. Heat may also be conducted away from the interior of a building to the roof and to other exterior surfaces or to the outside air if the interior is warmer.

Strategies to minimize excessive heat gain in summer and to reduce heat loss from buildings in winter are important for improving the energy efficiency of all types of structures. Some of the most effective improvements to buildings, in regard to their energy performance, can be made to the building “envelope”. The building envelope consists of the roof, walls, windows and doors. The envelope, therefore, is the outer shell of the building which is made up of all the components of the building that are in direct contact with the outside air, sunlight, rain and other weather conditions.

Several technologies for reducing roof temperatures during the summer months of the year, as well as technologies and methods to help block heat from entering other parts of a building (such as windows and walls), have been developed and put into practice. Likewise, technologies have been developed that help reduce the amount of heat that escapes through a building's envelope to the outside air in the wintertime. Improved insulation for ceilings and walls, more energy efficient glass for windows, window glazings and films, and radiant barrier materials for installation in attic spaces of residential buildings are some of these technologies. Rooftop water sprinkler systems have also been used to help lower the roof heat gain that can be a major concern on large commercial/industrial buildings during summer months.

Another methodology is the application of reflective coatings to a roof surface and/or the installation of white roofing membranes (known as “cool roof” technologies). Most cool roof technologies are bright white in color and are generally utilized on flat or low-sloped rooftops in warm climate zones. The objective is to provide and maintain a high level of reflectivity (along with a high degree of infrared emissivity) so that heat gain or “build up” on the rooftop is prevented by the turning away of the sun's light and heat. However, cool roof technology can be a significant drawback during winter months when it is desirable for the inside of a building to be warmer than the outside air. Heat from the sun that would otherwise be absorbed by the roof (and would thereby help to lower heating costs during winter months) is reflected away. In this instance, because the roof does not absorb and retain heat from the sun (as many other types of roofing materials do during wintertime), more heat may actually be lost from the interior of the building to the outside environment through the building's cool roof. Such heat loss during winter months may totally or partially offset the decrease in cooling costs during the summer. In fact, cool roof technology has not traditionally been recommended for certain areas which experience significant winters even though a cool roof might lower a building's cooling costs during the summer in those regions. (For example, California's cool roof incentive/rebate program has excluded certain areas of the state for that reason.)

When calculating the energy benefits of a cool roofing product or system to a particular building, architects, builders and energy engineers must take into account a wintertime “penalty”. This penalty does not have a very significant impact in regard to buildings located in areas that have mostly warm weather, such as Florida and some other southern states; however it should be evaluated when considering structures that are located in areas that experience very cold and lengthy winter conditions. The winter penalty is discussed in the paper “Painting the Town White—and Green” by Arthur H. Rosenfeld, Joseph J. Romm, Hashem Akbari and Alan C. Lloyd (published in MIT's Technology Review, February/March 1997 issue). According to this report, even though it seems that “the same steps that make buildings easier to cool in the summer also can make them more difficult (and expensive) to heat in winter”, the amount of direct light and heat from the sun falling upon the rooftop of a home is not nearly as great in winter as in the summer and, therefore, benefits can still be derived from choosing a cool roof. This example is given: “ . . . in a climate like that of the inland parts of Los Angeles . . . a homeowner will (spend) about $40 less for a season's worth of air conditioning if the roof is white rather than green. But the winter heat bill for the white-roofed home will be only $10 more than the green-roofed home, for a net savings of $30.” Since this example describes a residential application, it is probable that a more substantial winter penalty would need to be considered in commercial/industrial facilities with much larger roof areas. It is primarily the winter penalty for these larger facilities (within cooler climate zones) that needs to be addressed. Further, a system with much greater feasibility and value in times of high wintertime energy costs and/or times of increased emphasis upon energy independence, supply and security is needed.

Environmental credits may be obtained because, when electric energy is saved, less carbon dioxide (CO₂) and other pollutants such as NOₓ and SO₂ are released to the atmosphere by electric generating facilities, especially those whose fuel mixture contains a significant amount of coal. Therefore, it is recognized that improved energy efficiency translates to improved air quality. See “Linking Energy Efficiency and Air Quality: Energy Efficiency and Renewable Energy in the Nox Budget Trading Program” by the U.S. Environmental Protection Agency (EPA) (http://www.epa.gov/appdstar/state_local_govnt/state _outreach) accessed Mar. 20, 2003.

In another EPA document, “ENERGY STAR for Small Business,” within a section entitled “Putting Energy Into Profits” found on pages 23-24, “Pollution Prevented Through Energy Savings” is addressed. The importance of conserving energy is discussed; “For each kilowatt-hour (kWh) that you save through the application of energy-efficiency technologies, you are reducing the emissions of carbon dioxide, sulfur dioxide, and nitrogen oxides by the amounts shown in your region. Excessive carbon dioxide emission is a primary cause of global climate change; sulfur dioxide is a key constituent of acid rain; and nitrogen oxide is responsible for smog. You will save money and help the environment at the same time, and your customers will appreciate your efforts.” (Page 24) The report contains a map and chart listing the level of CO₂, SO₂ and NOₓ emissions that can reasonably be expected to be avoided (in each of the EPA's Pollution Emission Regions) for every one-thousand kWhs saved. In Region Six, made up of Texas and the surrounding four states, the chart shows that one-thousand seven-hundred pounds of CO₂ per year is capable of being saved per each one-thousand kWhs of energy conserved.

Additionally, in a presentation given in August, 2002, at the American Council for an Energy Efficient Economy summer conference in Pacific Grove Calif., the authors/presenters, Bruce R. Kinzey and Sonny Kim of Pacific Northwest National Laboratory and John D. Ryan of U.S. EPA, state that the buildings sector is “currently responsible for an estimated 35% of carbon emissions in the United States . . . ” and because of that, buildings are a “good target for carbon reduction efforts”. They state that numerous improvements to buildings can still be made, thereby having a significant, positive effect on carbon emissions reduction. They mention that the Intergovernmental Panel on Climate Change of the United Nations has concluded that “Hundreds of technologies and measures exist that can improve the energy efficiency of appliances and equipment as well as building structures in all regions of the world. (IPCC 2001)”. See “The Federal Buildings Research and Development Program: A Sharp Tool for Climate Policy.”

### SUMMARY OF THE INVENTION

The present invention meets the needs described above and provides other benefits through a system to prevent or minimize heat loss from a cool roof during colder weather. The invention includes a panel assembly made up of a suspension mechanism and an array of dark panels operably attached to the suspension mechanism to form a panel assembly. The panel assembly may be suspended over an exterior surface of a building where it decreases the reflection of solar radiation from the exterior surface. It may also form a layer of air between the exterior surface of the building and the panel assembly. Because the panel assembly is designed to ultimately allow the building to absorb more heat from solar radiation, it does not contain any structures for supplying water to the exterior surface of the building or the panels. The exterior surface of the building may be a roof, such as a white or cool roof. It may also be a wall or other exterior surface.

The suspension mechanism may include cables to which the dark panels are operably attached and anchors to which the cables are attached. Lightweight polymer blocks may be used to support the cables. Alternatively, it may include upright support posts, which may also be stabilized with lateral and transverse beams. Another suspension mechanism may be a scaffold. Multiple suspension mechanisms may be used for the same building, particularly if multiple exterior surfaces of the building are covered. The suspension mechanisms may be collapsible, removable or retractable. These features may be automatic.

The dark panels may be fabric, or they may be non-fabric or non-woven. In one embodiment, they are made of polypropylene. Photovoltaic cells may be affixed to the panels.

The panels may be attached to the suspension mechanism by a variety of fasteners including retention hooks, clamps, springs, turnbuckles, adhesives, springs and UV treated rope or cord. Fasteners may be designed to automatically release the panel to which they are attached when sufficient forces is applied. For instance, they may be designed to allow the array to be released from the suspension mechanism automatically if a certain weight of ice or snow builds up on the array.

The panel assembly may be suspended at any distance from the surface. The exact distance will vary depending upon the nature of the exterior surface, the use and type of the building and access needs. In some embodiments, it may be suspended between 1 and 2 feet above the exterior surface. In other embodiments it may be suspended between 6 inches and one foot above the exterior surface.

The present invention additionally includes a method of decreasing the reflection of solar radiation from an exterior surface of a building using the panel assemblies described above. Such assemblies may also be used to obtain governmental or corporate energy incentives, such as Energy Star status for the building. If the dark panels have photovoltaic cells affixed to them, the panel assembly may also be used to generate electricity. This electricity may be used in the building or supplied to a power grid.

For a better understanding of the invention and its advantages, reference may be made to the following description of exemplary embodiments and accompanying drawings.

### BRIEF DESCRIPTION OF THE DRAWINGS

FIG. 1 illustrates an overhead perspective view of an office building having a flat roof surface on which the panel assembly is installed in a horizontal operative position according to the teachings of the present invention.

FIG. 2 illustrates an overhead perspective view of an office building having a flat roof surface on which another embodiment of the panel assembly is installed in a horizontal operative position according to the teachings of the present invention.

FIG. 3 is illustrates a top view of a panel assembly according to the teachings of the present invention.

FIG. 4 illustrates a side elevational view of a panel assembly according to the teachings of the present invention.

FIG. 5 illustrates a perspective view of a fabric fastener according to teachings of the present invention.

### DETAILED DISCUSSION OF THE INVENTION

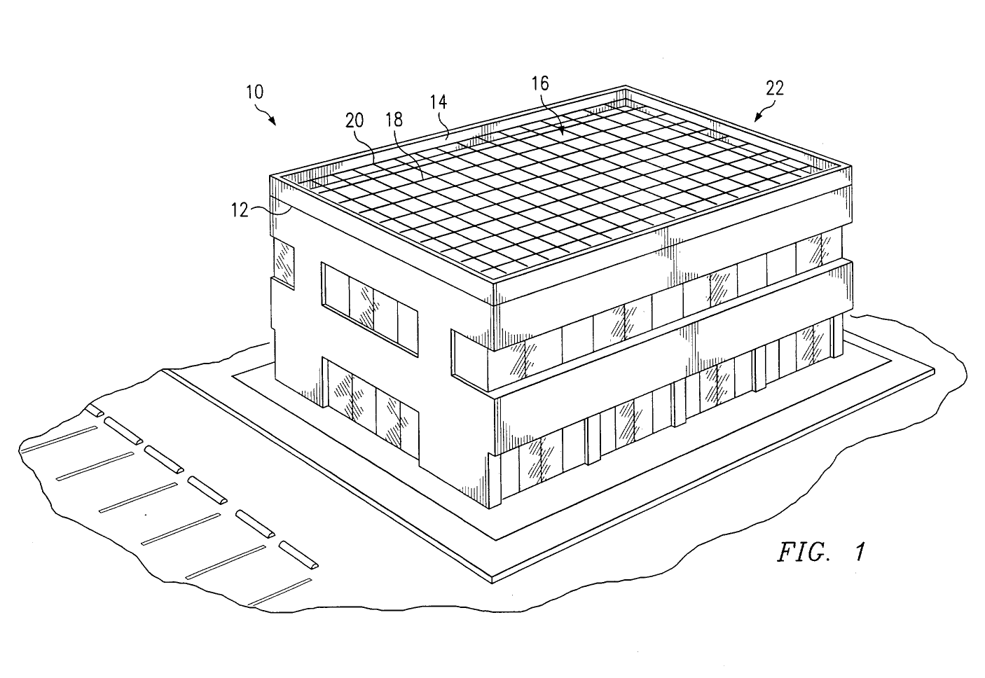

Specific embodiments of the present invention and their advantages are best understood by reference to FIGS. 1 through 5, where like numbers are used to indicate like and corresponding features. Referring to FIG. 1, the panel assembly 22 is installed in an operative position overlying the white or reflective roof (“cool roof”) 12 of a building 10 for the purpose of absorbing solar radiation and reducing or preventing its reflection by the roof. The panel assembly 22 includes cables 18 attached to a parapet wall 14 of the building 10 with anchors 20 and dark or radiation absorbent (hereinafter “dark”) panels 16 fastened to the cables 18 so that the panels are in an operative, solar absorbing or reflection preventing position overlying the roof 12.

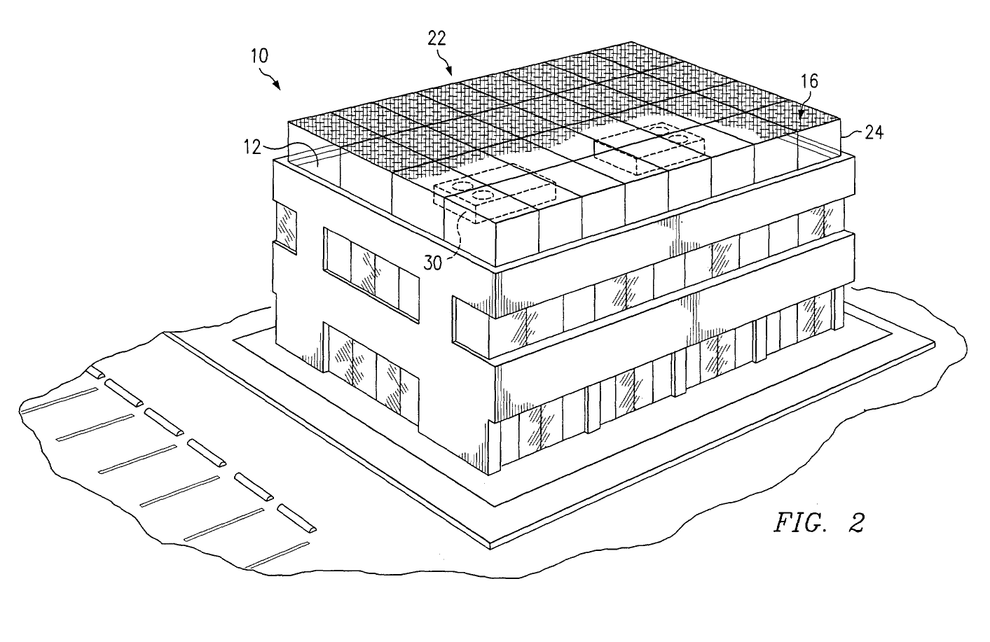

Referring to FIG. 2, the panel assembly 22 is installed in an operative position overlying the cool roof 12 and rooftop machinery 30 of a building 10 for the purpose of absorbing solar radiation and reducing or preventing its reflection by the roof. The panel assembly 22 includes upright support posts 24 to which dark panels 16 are attached so that the panels are in an operative solar absorbing or reflection preventing position overlying the roof 12.

Referring to FIG. 3, the panel assembly 22, as shown in FIG. 1, includes cables 18 attached to a parapet wall 14 via anchors 20. Dark panels 16 are attached to the cables 18 with fasteners 26.

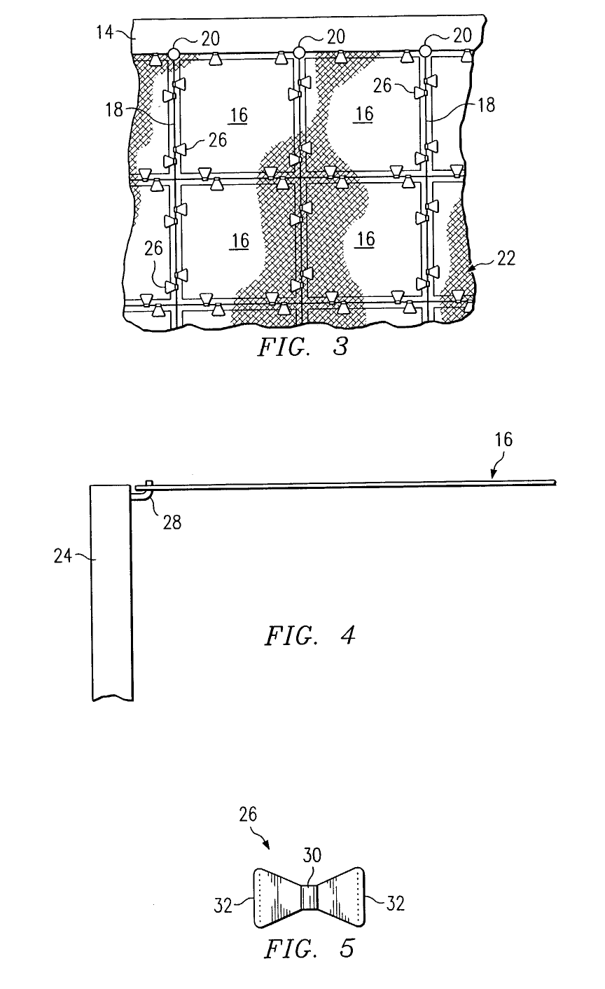

Referring to FIG. 4, the panel assembly 22, as shown in FIG. 2, includes an upright support post 24 to which the dark panel 16 is attached through retention hook 28.

FIG. 5 illustrates a fabric fastener 26 which, in the unclosed position, includes a central raised area 30 through which the cable may pass and two flaps, 32, which are brought into proximity around the fabric of a dark panel when the fastener is closed.

Fasteners

Although fasteners and retention devices such as fastener 26 and retention hook 28 are discussed and illustrated herein, it will be apparent to one skilled in the art that a variety of retainers or fasteners, including ties, clamps, hooks, springs, turnbuckles, adhesives and UV-treated rope or cord may be used within the scope of the present invention to attach any of the dark panels to support posts, cables or other support structures in such a manner so that they are overlying a roof, thereby providing a reliable support/fastening strategy for the shade panels.

Fastening devices exist to allow the release of shade panels when excessive weight is present upon the panels due to snow or ice loads during the winter months. Those fastening devices may be utilized as part of the present invention, for instance when the panel system is installed on buildings in areas that have historically experienced significant numbers of snow and/or ice storms. After release from the support structure or framework, the panels rest upon the surface below until such time that the snow or ice melts or is otherwise removed, and then the panels are easily restored to the former operative position. Fastening devices manufactured and sold by Simpson Strong-Tie and Pak-Unlimited may be used to secure the panel assembly of the present invention. Many of the Simpson Strong-Tie fastening and anchoring devices have been extensively tested and proven effective under high-wind and/or coastal conditions. These fasteners and anchors, or fastening devices of similar superior strength and reliability, may be used when installing the panel assembly of the present invention in areas that are prone to windstorms of various types and intensities, such as tropical storms experienced in coastal locations.

Panels

The dark panels 26 may be black, dark grey, dark brown or any other hues that are low in reflectivity of the sun's light or highly absorbent of solar radiation. In an exemplary embodiment, the panels are rectangular and are made of a solar radiation absorbent fabric. They may be constructed of polypropylene shade fabric, for example as sold under trademark NICO-SHADE (by TC Baycor Corporation). For an 80% shade factor, the NICO-SHADE fabric has a weight of 3.7 ounces/square yard, an air porosity of 700 cfm, with the polypropylene yarn having an oval warp and a round fill. In another exemplary embodiment, the dark shade screens are rectangular and are constructed of dark vinyl-coated polyester, for example as sold under the trademarks SunTex 80 or SunTex 90 (by Phifer Wire Products, Inc.) in the black, grey or brown colors.

Other types of knitted or woven shade fabrics may be selected to serve as panels (whether porous or non-porous) as well as certain types of nonwoven materials that would be durable enough and capable of solar absorption/heat retention. Some types of silver, “aluminized” materials exist and have been utilized on greenhouses for providing extra warmth to plants during wintertime in some locations. Such aluminized materials may also be used, either alone or in conjunction with other suitable materials or fabrics, to form the panels of the present invention.

Any panels utilized may be installed in single layers only, in some embodiments, or in two or more layers (either in contact with each other or separated by a layer of air or other material) depending upon the degree of roof “warmth” that is desired and upon the technical properties of the type(s) of materials selected to serve as panels. When used as an energy-saving strategy on buildings having skylights in place across all or a portion of the existing roof surface, the panels of the present invention may be made up of a thinner radiation absorbent material that also has a higher level of transmissitivy and thus a lower shade factor. Such panels would allow more sunlight to filter through to the skylights, thereby allowing a sufficient level of natural light (or “daylighting”) to reach the building's interior while the panel system would continue providing energy-saving and other benefits due to its presence across the rooftop. Use of natural light, especially in school buildings and in some industrial settings, has been proven to provide enhanced levels of productivity to the inhabitants of those buildings; and it is often seen as an energy-saving strategy itself since the number of electric light fixtures required may be reduced. It is not required that the panels of the present invention interfere with the use of daylighting in building design. In fact, they may be customized to allow the desired level of natural light into the facility.

Additionally, the panel materials of the present invention may be fitted or embedded with lightweight, relatively low-cost, solar (photovoltaic) cells so that, other than serving to simply “warm” a cool roof in winter (and thereby helping to reduce the amount of energy required to heat the building to a comfortable level for the building's occupants while saving money on heating costs for the building owner), clean, renewable energy from the sun can also be provided for the building's use or to be sent to a local or regional electric grid system for distribution elsewhere. The panels of the present invention can serve as a new surface to which such solar cells can be affixed. Building designers have recently been developing ways to incorporate solar components into common building materials such as glass for windows/doors, facades, etc. The panels of the present invention can serve as a new, cost-effective surface to which such solar cells can be affixed. The light from the sun falling upon the panels for example, (either fitted with solar cells around the perimeter of each, or having the solar cells affixed across the complete or partial surface area of each) can be converted to electricity by passing through the proper conversion equipment and sent/transferred to the building for its immediate use, for storage or for transfer to the distribution system of a local electric utility company.

If this type of panel is put into use on buildings, renewable energy credits (RECs) may be obtainable, as well as rebates or any other incentives that either now exist or that may become available in the future. In addition to RECs, the installation of the panel system of the present invention onto buildings in certain locations around the world (either with or without solar cells being incorporated onto the panels of said system) may generate environmental credits (such as carbon-reduction or greenhouse gas mitigation credits) that may have economic value and may be sold, traded or banked for future use.

Anchors and Support Posts:

Anchors 20 may be attached to any portion of the building or rooftop structures so long as the dark panels and cables will be overlying the rooftop. To locate the panels above rooftop machinery 30, in an exemplary embodiment such as that of FIG. 2, panels 16 are suspended above rooftop 12 and machinery 30. Anchors 20 may be attached to the interior of a facade or parapet wall 14. Anchors 20 may also be placed as necessary on rooftop machinery and structures such as air conditioner support platforms. Anchors may be in any form. In specific embodiments they may be similar to those sold by Pak-Ulimited.

Slight modifications to the exterior walls of the building or to rooftop structures may be necessary, in some instances, to facilitate appropriate anchor attachment. One possible modification of a building lacking a parapet wall may be the addition of low, upright posts along the roof edge to which the cables may be attached. When needed, very strong, lightweight styrofoam or other lightweight polymer blocks (not expressly shown) such as types commonly available for construction uses may be placed under the cables and secured in place. In an exemplary embodiment, they may be placed where the cables attach to the anchors or support posts and where the cables cross each other. The blocks provide load-bearing support to the cables, and are not likely to damage the roof in any way. The blocks may be attached firmly to the roof surface and/or to each other with glue or other suitable adhesives. A low wall of the blocks may be constructed around the perimeter of a roof lacking a parapet wall in order to provide a substitute structure to which anchors 20 may be attached. Heavier block-type materials may be used if the selected building has walls and a roof area that were designed and built to bear extra weight. Further, in applications involving a sustainable or “green” building project, any such block-type material selected may be made from recycled material (such as recycled rubber or a strong, recycled plastic) or the blocks themselves may be recyclable.

In another embodiment of the invention illustrated in FIGS. 2 and 4, retainer hooks 28 may be attached to upright support posts 24. The dark panels 16 may then be stretched tightly between posts 24. Upright support posts 24, which extend one foot or less above the roof in certain embodiments, may be stabilized by multiple lateral and transverse beams (not expressly shown) that connect adjacent pairs of upright support posts, thereby defining a rectangular, relatively low framework that is horizontally displaced and vertically offset from the roof. If necessary, support posts 24 may be permanently mounted on the roof of existing buildings by integrating them into the roof structure by various methods, including drilling holes in the roof structure through which the posts may be placed and fastened securely to whatever suitable structural supports exist in that particular building at the roof deck level or below. Any support posts deemed necessary, in regard to newly constructed buildings, may be planned for in advance and designed into the engineering specifications for said building.

Support posts 24 may also be part of a removable structure. For instance, support posts 24 may be stabilized by lateral and transverse beams at both the top and bottom to produce a scaffolding which may be placed upon the roof and secured during cooler months, when panel assembly 22 is in use, then removed during warmer weather.

A cable-supported roof warming assembly may also be designed to be retracted or removed entirely from the roof in the summertime. Removing or retracting the panel assembly may be accomplished either manually or by any number of automated control systems the same as, or similar to, those used to control automated, retractable shade panel systems that are a feature of some greenhouse structures sold within the horticultural industry. Retractable shade systems have existed in greenhouse applications, for the protection of plants and crops, but usually not as part of roofing systems for commercial, industrial or residential buildings. It is envisioned that such a retractable system may be built to allow the dark shade panels of the present invention to be pulled to the sides of the building in the warm months of the year (when the building is entering its cooling season), thereby allowing the cool roof product to resume its job of reflecting the sun's light/heat from the rooftop. The dark panels can be returned to the unretracted position, either manually or automatically, when the seasons change and the building is entering its heating season. Such a retractable control system, for positioning the dark shade panels, may be equipped with various sensors such as temperature sensors and/or photoelectric cells to sense the presence of sunlight so that the panels may be pulled to the side(s) of the building, the retracted position, when there is sufficient sunlight falling upon the roof area that the cool roof should be freely exposed to the sky in order to reflect sunlight and reduce heat gain on the rooftop. Weather information may also be supplied to such a control system from the internet and sent to the device through a computer-based building management system.

The panel assembly of the present invention, whether retractable or not, may be designed and constructed so that the finished product resembles any geometric shape currently used within the greenhouse design and/or the commercial building architectural/engineering communities so that the assembly will be both structurally sound and aesthetically pleasing. Therefore, other than an essentially horizontal installation, the panel assembly of the present invention may be constructed on a building rooftop in a series of arches, peaks or any other type of geometric shape, such as a pyramid or many small ones, that encompasses all or a majority of the roof area. For decorative and/or commercial purposes, various designs or corporate logos may be sewn or printed onto the panels of the present invention, and appropriately-selected outdoor lighting assemblies may also be added beneath the panels at various locations on the roof surface so that the rooftop may be more attractive at night when viewed from the windows or balconies of taller structures nearby.

Additionally, all or part of the panel assembly of the present invention may be designed so that it may be collapsed to lay flat on the roof to allow access, to prevent breakage under heavy weight, or for other reasons. In one embodiment, the collapsible assembly may be supported by deflatable air bags. Anchors and/or upright support posts may also be designed to allow collapse. In certain embodiments, the collapse mechanism will be easily reversible to the uncollapsed position.

Panel assembly 24 may be placed at any distance above the roof. In an exemplary embodiment, it is approximately one to two feet above the roof surface. In another embodiment, it may be placed 0.5 to 12 inches above the roof or approximately six inches above the roof. Various considerations may affect the placement and whether the assembly primarily uses support posts 24, anchors 20 and cables 18 or another support mechanism. These considerations include the presence or absence of a parapet wall, rooftop machinery, other building features, and aesthetics. Weather and climate may also affect the placement and structural choices. For example, in a particularly windy climate, a very low placement may be desirable to facilitate the formation of a warm layer of air between the panel assembly and the roof surface. Thus, the panel assembly and the layer of warm air between it and the roof surface can serve as a new, extra “insulation” layer above the roof that can help block heat loss from the building to the night sky.

In an earlier unpublished study of a similar panel assembly system, commissioned by the inventors of the present system and conducted privately by Dr. Joe Huang of Joe Huang and Associates, the DOE2 energy modeling software was used to project energy benefits of the technology that was assumed to be installed four feet above the roof surface. Dr. Huang found that there is projected to be a wintertime energy savings, most likely due to the presence of the panels over the rooftop that serve to block longwave radiation from the building and rooftop to the night sky. The panel assembly of the present invention is expected to serve that function, no matter what height above the rooftop the panel assembly is installed, and may result in more wintertime energy savings.

Panel assembly 22 may also be situated in such a way that rooftop machinery or other features are covered or left uncovered. In one embodiment, shown in FIG. 2, the panel assembly is at a uniform height sufficient to cover all rooftop machinery. In another embodiment, the assembly may be at a lower height and machinery or other elevated rooftop features may be left uncovered. Alternatively, a special support post and/or cable framework to which dark panels are attached may be built around the machinery allowing it to be covered. Whether and how machinery is covered may be influenced by cost, efficiency and weather considerations as well as by any other possible effects such as potential overheating or freezing that could possibly result due to the covering of the equipment by the panel assembly.

The present invention also includes the use of dark panels on, or slightly offset from, the walls of a building. The panels may be suspended from a framework or a series of cables attached to the facade or parapet wall, or they may simply be suspended from the external wall itself where it meets the roof. The dark panels may also be supported by a free-standing framework parallel to the wall but not supported by the wall itself. Such a framework may be anchored to the ground. In yet another exemplary embodiment, the dark panels may be attached to cables running from the edge of the rooftop or facade to the ground below at an angle. Dark panels may be easily removed along with any cables or other removable support materials to allow heat reflection in warmer months, assuming the walls are constructed of a light-colored material or painted white or another reflective color. Such seasonal removal of the dark panel assembly for entire walls may be accomplished either manually or by utilizing an automated system as described above (a “retractable” control system). It is projected that, in regard to certain buildings, the provision of panel assemblies along entire exterior walls may enable significant additional energy savings due to the extra layer of “insulation” created. The placement/installation of the exterior wall-insulating panel assembly may occur at various distances from the wall surface, as desired; and in windy locations, it may be installed as close to the wall as possible (within a two foot distance or less, for example) in order to facilitate a warm layer of air between the wall and the panel assembly. Use of a wall panel assembly in certain embodiments may help prevent cooling of the building due to reflection from a light colored wall.

A panel assembly of the present invention that is put into an operative position attached to or near an entire exterior wall of a structure may also have the same type of solar cell enhanced panels previously described herein. Adding affordable solar cells to the panels meant to be in an operative position near or attached to walls, especially long walls that normally receive the most afternoon light and heat, may be very beneficial in the wintertime when the sunlight strikes the building from a different angle than in the summer due to the seasonal tilt of the earth. Such a solar cell enhanced wall panel assembly can be utilized whether solar cell enhanced panels are put in place over the roof area or not. It may be most beneficial, in some cases, to suspend dark panels without solar technology incorporated into them over the roof area in winter and to utilize panels enabled with solar technology along suitable wall areas; however it is estimated that more energy can be derived from sunlight on most buildings in winter if the solar cell enhanced panels were used over the roof area and suitable wall areas, as well.

Additional Benefits to the Cool Roof Technology:

The panel assembly of the present invention may allow use of cool roof technologies to be expanded into geographic locations where they are not presently recommended due to a real or perceived winter “penalty”. Such a widening of suitable markets for the cool roofing products would be beneficial to the cool roofing industry. The panel assembly of the present invention may extend the useful service life of a cool roof by providing a certain level of shade to it throughout all or part of the year and by helping to keep it cleaner, thus maintaining its reflectivity at a desired level for longer periods of time. To qualify for an Energy Star label, the cool roof materials must be tested for reflectivity. They must have at least a 65% reflectance level upon initial installation and must maintain a 50% reflectivity or more after three years of service on a building. Therefore, the panel assembly of the present invention may provide a significant longevity benefit to certain cool roofing products allowing them to attain Energy Star status.

The shade panels of the present invention may be exchanged for panels having a lower “shade factor” if the system is to be left in place throughout the spring and summer months. For example, instead of 80% or 90% shade factor fabric panels remaining in place when warm weather approaches, the panels may be replaced with even lighter weight (and lower shade factor) panels that will allow more light transmittance to the cool roof surface below, while still providing some shading to the cool roof, thereby helping to maintain the effectiveness of the product's reflectivity. In such embodiments in which the panel assembly may be kept in place year round, even if panels are switched out seasonally, there may be other benefits to the cool roof surface, such possible protection from hail damage. When hailstones hit any type of opaque roofing surface, damage can occur. Roofing consultants Benchmark, Inc. have reported photographs of hail damage on various roofing surfaces.

The panels of the present invention may also offer substantial protection from windblown debris (such as sand, dirt, gravel, broken tree limbs or other items that may be picked up by a sudden windstorm) to the roof and/or walls of a structure. In the case of a rooftop employing cool roofing materials, the panels of the present invention may serve a screening function helping to greatly reduce the amount of dirt, dust and industrial pollutants reaching the cool roof surface. This additionally helps the panel assembly maintain the reflectivity of those white or light-colored surfaces, as keeping them clean is important to their effectiveness, longevity and level of reflectivity.

Although only exemplary embodiments of the invention are specifically described above, it will be appreciated that modifications and variations of the invention are possible without departing from the spirit and intended scope of the invention.

What is claimed is:

1. A panel assembly comprising:
a) a suspension mechanism;
b) an array of dark panels operably attached thereto to form a panel assembly;
wherein the panel assembly is suspended over an exterior surface of a building;
wherein the panel assembly decreases reflection of solar radiation from the exterior surface; and
wherein the panel assembly does not contain any structures for supplying water to the exterior surface or panels.

2. The panel assembly of claim 1, wherein the suspension mechanism further comprises cables to which the dark panels are operably attached.

3. The panel assembly of claim 2, further comprising the anchors to which the cables are attached.

4. The panel assembly of claim 1, wherein the suspension mechanism further comprises upright support posts.

5. The panel assembly of claim 4, further comprising lateral and transverse beams operably attached to the upright support posts.

6. The panel assembly of claim 1, wherein the suspension mechanism further comprises a scaffold.

7. The panel assembly of claim 1, further comprising a collapsible suspension mechanism.

8. The panel assembly of claim 1, further comprising a removable suspension mechanism.

9. The panel assembly of claim 1, further comprising a retractable suspension mechanism.

10. The panel assembly of claim 8, wherein the retractable suspension mechanism automatically suspends and retracts the array dark panels.

11. The panel assembly of claim 1, further comprising fabric dark panels.

12. The panel assembly of claim 1, further comprising non-fabric or non-woven panels.

13. The panel assembly of claim 1, further comprising polypropylene fabric panels.

14. The panel assembly of claim 1, further comprising at least one photovoltaic cell affixed to at least one dark panel.

15. The panel assembly of claim 1, further comprising at least one fastener operable to attach the array of dark panels to the suspension mechanism, wherein the fastener is selected from the group consisting of: retention hooks, clamps, springs, turnbuckles, adhesives, springs and UV treated rope or cord.

16. The panel assembly of claim 1, further comprising at least one fastener operable to attach the array of dark panels to the suspension mechanism, wherein the fastener automatically releases when sufficient force is applied to the array of dark panels.

17. The panel assembly of claim 2, further comprising lightweight polymer blocks operable to provide structural support to the cables.

18. The panel assembly of claim 1, wherein the panel assembly is suspended between 1 and 2 feet above the exterior surface.

19. The panel assembly of claim 1, wherein the panel assembly is suspended between 6 inches and one foot above the exterior surface.

20. The panel assembly of claim 1, wherein the exterior surface is a roof.

21. The pane assembly of claim 20, wherein the roof is a white roof or cool roof.

22. A method of decreasing the reflection of solar radiation from an exterior surface of a building comprising:
a) operably attaching an array of dark panels to a suspension mechanism; and
b) suspending the array of dark panels over the exterior surface;
wherein the panel assembly decreases reflection of solar radiation from the exterior surface; and
wherein the panel assembly does not contain any structures for supplying water to the exterior surface or panels.

23. A method of obtaining environmental incentives from a government or corporation comprising:
a) operably attaching an array of dark panels to a suspension mechanism;
b) suspending the array of dark panels over the exterior surface; and
c) applying for an environmental incentive;
wherein the panel assembly decreases reflection of solar radiation from the exterior surface; and
wherein the panel assembly does not contain any structures for supplying water to the exterior surface or panels.

24. The method of claim 23 further comprising applying for Energy Star status for the building.

25. A method of generating electricity comprising:
a) operably attaching an array of dark panels to a suspension mechanism;
b) suspending the array of dark panels over the exterior surface; and
c) affixing at least one photovoltaic cell to at least one dark panel;
d) generating electricity using the photovoltaic cell;
wherein the panel assembly decreases reflection of solar radiation from the exterior surface; and
wherein the panel assembly does not contain any structures for supplying water to the exterior surface or panels.

26. The method of claim 25 further comprising using the electricity within the building.

27. The method of claim 25 further comprising supplying the electricity to a power grid.
